(19) United States
(12) Patent Application Publication
(10) Pub. No.: US 2007/0004832 A1
(43) Pub. Date: Jan. 4, 2007

(54) Use of tocopherol to scavenge acetaldehyde in polyethylene terephthalate containers

(75) Inventor: Peter Prusak, Avon Lake, OH (US)

Correspondence Address: POLYONE CORPORATION, 33587 WALKER ROAD, AVON LAKE, OH, 44012, US

(73) Assignee: POLYONE CORPORATION, Aon Lake, OH (US)

(21) Appl. No.: 10/595,278

(22) PCT Filed: Oct. 1, 2004
(86) PCT No.: PCT/US04/32646

§ 371 Date: Apr. 4, 2006

Related U.S. Application Data
(60) Provisional application No. 60/511,455, filed on Oct. 15, 2003.

(51) Int. Cl. C08K 5/15

(52) U.S. Cl. 524/110; 524/107; 524/605

(57) ABSTRACT

A polymeric compound is disclosed comprising polyethylene terephthalate and DL-alpha-Tocopherol. DL-alpha-Tocopherol serves as a scavanger for acetaldehyde in headspace of containers comprising polyethylene terephthalate.

### CLAIM OF PRIORITY

This application claims priority from U.S. Provisional Patent Application Ser. No. 60/511,455 bearing Attorney Docket Number 12003018 and filed on Oct. 15, 2003.

### FIELD OF THE INVENTION

This invention relates to use of a means to scavenge acetaldehyde in containers made from polyethylene terephthalate (PET).

### BACKGROUND OF THE INVENTION

Plastic has taken the place of other materials in a variety of industries. In the packaging industry, plastic has replaced glass to minimize breakage, reduce weight, and reduce energy consumed in manufacturing and transport.

Polyethylene terephthalate (PET) is very often used as a plastic for replacement of glass in the packaging industry, particularly the beverage container industry.

U.S. Pat. No. 5,874,517 (Huang et al.) discloses the problems in the art of regenerated acetaldehyde in PET resin and their method for solving that problem.

As described in Huang et al., acetaldehyde is one of several byproducts created during PET polymerization, and remains in the polymer chip after polymerization is completed. Acetaldehyde must be minimized because it can introduce flavor to the drinks contained in the bottles, which is highly undesirable. The acetaldehyde trapped in the chip during the polycondensation reaction to prepare PET, is widely known as “free” acetaldehyde. In addition to free acetaldehyde, acetaldehyde may also be formed by the further reaction or decomposition of PET and other byproducts (“acetaldehyde precursors”) trapped in the polymer chip during polymer manufacture. Acetaldehyde produced from the reaction of trapped acetaldehyde precursors or which is formed during degradation occurring during the molding process is referred to as “regenerated” acetaldehyde. Reactions which produce regenerated acetaldehyde are induced when the polymer is subjected to high temperatures, such as those temperatures utilized in the injection molding process.

Huang et al. reports that antioxidants have been widely studied and used for preventing PET thermal and thermal oxidative degradaptin. But none reported by Huang et al. worked in order to reduce regenerated acetaldehyde while also maintaining color values acceptable for bottle resin.

U.S. Pat. No. 6,569,479 (Rule) discloses an oxidation catalyst active for the oxidation of acetaldehyde to acetic acid to be used in a beverage container.

### SUMMARY OF THE INVENTION

As Huang et al. stated, a need exists for a commercially acceptable PET resin which does not generate significant amounts of acetaldehyde when heated for molding into a container or bottle.

The present invention solves this problem but in a way unexpected by one of ordinary skill in the art, after taking into consideration the disclosures of Huang et al. and Rule.

One aspect of the present invention is a method of using DL-alpha-tocopherol to scavenge acetaldehyde from head space of a beverage container comprising polyethylene terephthalate.

Another aspect of the present invention is a polymeric container comprising compound comprising polyethylene terephthalate and an acetaldehyde scavenger comprising DL-alpha-Tocopherol.

A feature of the invention is the ability of DL-alpha-tocopherol to reduce concentration of acetaldehyde from head space of a beverage container containing a consumable beverage, especially one which has its taste affected by the presence of acetaldehyde in an enclosed beverage container.

An advantage of the invention is that commercial sources for DL alpha tocopherol readily exist and are otherwise approved for use with food.

Other features and advantages will become apparent in a review of the following embodiments.

### EMBODIMENTS OF THE INVENTION

PET Resin

The terms “polyethylene terephthalate” and “PET” as used herein are used generally to include high-molecular weight polymers made by condensing ethylene glycol with dimethyl terephthalate or terephthalic acid no matter how prepared. Furthermore, these terms are meant to include well-known polyethylene terephthalate polymers which are modified by the inclusion of minor amounts, e.g., less than about 20 percent by weight of the polymer, of comonomers or modifying agents, as is otherwise well known.

Such comonomers or modifying agents include aromatic and aliphatic diols and polyols; aromatic and aliphatic carboxylic acids; or single molecules containing both carboxylic and alcohol functionality. Examples of diols include 1,4-butanediol, cyclohexanedimethanol, diethylene glycol and/or 1,3-propanediol. Examples of carboxylic diacids include isophthalic acid, adipic acid, 2,6-naphthalene dicarboxylic acid and p-hydroxy benzoic acid. Minor amounts of chain branching agents and/or chain terminating agents may also be used. Such chain branching agents include, for example, polyfunctional acids and/or polyfunctional alcohols such as trimethylol propane and pentaerythritol. Chain terminating agents include monofunctional alcohols and/or monofunctional carboxylic acids such as stearic acid and benzoic acid.

Mixtures of chain branching and chain terminating agents may also be used. PET which contains such chain branching agents and chain terminating agents is described in U.S. Pat. No. 4,161,579.

The PET can be prepared by either a batch or continuous polymerization process by any means known to those having ordinary skill in this art. For example, PET can be prepared by the ester interchange (transesterification) of dialkyl esters of terephthalic acid such as dimethyl terephthalate or by the esterification of terephthalic acid with ethylene glycol.

PET reaction product can then be extruded at an elevated temperature into water and allowed to solidify therein. The solid PET can then be pelletized by means known to those skilled in this art. For example, the PET may be pelletized using an underwater pelletizer.

The PET useful in the present invention can in any form such as pellets, chips, granules, or powders, for further compounding and processing.

Alternatively, PET can be polymerized in a continuous process that includes an extrusion step at the end of the process.

The intrinsic viscosity of PET ranges from about 0.50 to about 1.0, preferably from about 0.65 to about 0.85 deciliters per gram based upon calculations made from measurements in o-chlorophenol at 25° C. The specific preferred range of intrinsic viscosity depends on end use.

A type of PET resin that may be of use in the present invention is that PET resin prepared according to the method disclosed in U.S. Pat. No. 5,874,517 (Huang et al.).

Acetaldehyde Scavenger

The acetaldehyde scavenger is DL-alpha-Tocopherol. It is commercially available as antioxidant for plastics from BASF Corporation under the brands Uvinul® 2000 AO and Uvinul® 2003 AO. As reported by BASF Corporation, Uvinul® 2000 AO is pure DL-alpha-Tocopherol, whereas Uvinul® 2003 AO is DL-alpha-Tocopherol modified by inclusion of an organophosphorus compound. Both are reported for use as inhibiting thermooxidative degradation.

DL-alpha-Tocopherol can be added to the PET resin in an amount ranging from about 1.25% to about 18%, and preferably from about 5% to about 16.7% weight percent of the total compound.

In the event that the compound is to be supplied to customers as a concentrate, the DL-alpha-Tocopherol can be added to the PET resin in an amount ranging from about 1.25% to about 18%, and preferably from about 5% to about 16.7% weight percent of the total compound acting as a concentrate.

Any conventional means to thoroughly mix the ingredients can be used in the present invention. Preferably, the ingredients are mixed using any conventional high intensity mixing apparatus without any special order of addition, at ambient temperature and sufficient mixing speed to thoroughly mix the ingredients.

In addition to the compound being available as a compound (fully “let-down”) and a concentrate, the compound can be prepared for use in the form of particulates according to the disclosure in U.S. Pat. Publication 20020198122 (Nitzsche).

It is unexpected that DL-alpha-Tocopherol functions as a scavenger for acetaldehyde. But proof of that function is found in the examples below.

Optional Ingredients

Any conventional polymeric additive can be considered for addition to compounds of the present invention. Non-limiting examples of such optional additives include slip agents, antiblocking agents, antioxidants, ultraviolet light stabilizers, quenchers, plasticizers, mold release agents, lubricants, antistatic agents, fire retardants, and fillers such as glass fibers, talc, chalk, or clay. Of these fillers, the properties of nanoclay can add stiffness, toughness, and charring properties for flame retardancy. Such optional additives can be included in the blend of the present invention in an amount from about 0 to about 40, and preferably from about 0.1 to about 30 weight percent. Most preferably, the amount is about 1 to about 7 weight percent of the blend.

Any conventional colorant useful in thermoplastic compounding is also acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others. The amount of colorant can range from none at all to about 4.0, and preferably from about 1.5 to about 2.0 weight percent of the total polymeric compound.

### USEFULNESS OF THE INVENTION

Compound of PET and DL-alpha-Tocopherol according to the present invention can be used to produce containers such as PET beverage bottles for mineral water, carbonated liquids, white liquors, white wine, and PET food containers for cheese.

Compounds containing PET and DL-alpha-Tocopherol according to the present invention can be molded into containers of various shapes by various means, including without limitation, reheat blow molding, injection blow molding, extrusion blow molding, and others known to those skilled in the art.

It is reported by Huang et al. that bottle manufacturers specify acceptable levels of acetaldehyde based on measurements made in the bottle's head space subsequent to molding. Bottle head space acetaldehyde specifications are generally less than 4 μg/l for cola beverages and less than 1 μg/l for water applications.

### EXAMPLES

PET bottles were prepared according to the recipes and commercial sources stated in Table 1 and the molding conditions stated in Table 2.

TABLE 1
Recipes

| | Comp. | | | | |
|---|---|---|---|---|---|
| Ingredient Wt. % | Ex. A | 1 | 2 | 3 | 4 |
| Uvinul 2000 AO | — | 1.25% | 5% | — | — |
| Uvinul 2003 AO | — | — | — | 16.7% | 6.7% |
| PET Polymer (0.8 I.V. | 40% | 39.50% | 38% | 33.3% | 37.3% |
| Pellet) | | | | | |
| PET Polymer (0.8 I.V. | 60% | 59.25% | 57% | 50% | 56.0% |
| Powder) | | | | | |

Commercial Sources

| Ingredient and Use | Source | Generic Name |
|---|---|---|
| Uvinul 2000 AO Acetaldehyde Scavenger | BASF | DL alpha |
| | | Tocopherol |
| Uvinul 2003 AO Acetaldehyde Scavenger | BASF | DL alpha |
| | | Tocopherol |
| PET Polymer (0.8 I.V. Pellet) Resin | GE | Polyethylene |
| | | terephthalate |
| PET Polymer (0.8 I.V. Powder) Resin | GE | Polyethylene |
| | | terephthalate |

TABLE 2
Bottle Making Conditions

| | | | | | |
|---|---|---|---|---|---|
| Example | Comp. Ex. A | 1 | 2 | 3 | 4 |

| | |
|---|---|
| Compounding Equipment | Co-rotating Twin Screw Extruder |
| Compounding Temperature | 259° C. Melt Temp |
| Compounding Mixing Speed | 250 rpm |
| Molding Equipment | Aoki 100LL-20 |
| Mold Shape and Size | Boston Round 0.3 mm wall thickness |
| Molding Temperature | 270° C.-290° C. |
| Molding Injection Pressure | 50 psi (0.344 mPa) |
| Bottle Size | 12 oz (354 ml) |

The bottles were fitted with an internal septa and capped with a bottle cap drilled to permit insertion of an acetaldehyde sampling tube. To sample the bottles, the serum cap was lanced with a knife and then the sampling tube was inserted through the hole in the bottle cap. A 3.1 mm hole was made near the bottom of the bottle to let air into the bottle while sampling. The industrial hygiene pump was turned on immediately upon placing the hole in the bottom of the bottle.

Air (18 to 35 liters) was pulled through the bottles to sweep exhaustively the acetaldehyde into the sampling tube. The air exchanges compared to the bottle volume were well in excess of that needed to exchange the air volume.
Sampling Tube: SKC 226-119 (6 mm by 110 mm with two sections 150/300 mg of DNPH coated silica gel)
Sampling Pump: SKC “Airchek Sampler” pump model 224-PCXR8
Sampling flow rate: nominal 0.4 to 0.5 liters/min
Tube Preparation: Desorb front half and back half of sampling tube separately each with 3 mis of acetonitdile.
   IH HPLC Method: (NIOSH 2016, modified for Acetaldehyde)
   Instrument: Waters Model 2690 LC System
   Column: Phenomenex LUNA C18 (4.6 by 50 mm)
   Column Temp: 30° C.
   Injection Volume: 15 μl
   Mobile Phase:
   Phase A=10:90 Acetonitrile:Water with 0.7708 g/L ammonium acetate
   Phase B=90:10: Acetonitrile:Water with 0.7708 g/L ammonium acetate
   Flow rate: 0.75 ml/min

Gradient Program:

| Time, min | % A | % B | Curve |
|---|---|---|---|
| Initial | 90 | 10 | * |
| 4.0 | 38 | 62 | 6 |
| 8.0 | 38 | 62 | 6 |
| 10.0 | 90 | 10 | 6 |

Retention time acetaldehyde-DNPH derivative: 6.7 nm
Detection: UV at 360 nm
The interior spaces of PET bottles were sampled for acetaldehyde at two different intervals from sealing of the bottles on Day 1.0. On Day 11 for Examples 1 and 2 and Day 21 for Examples 3 and 4, the seals were removed from the bottles and were sampled for acetaldehyde presence using an exhaustive air exchange performed according to NIOSH Test No. 2016, described above to capture any acetaldehyde present in the head space of the bottle onto a sampling tube. As explained above, the acetaldehyde was derivatized by dinitrophenylhydrazine (DNPH) coated onto silica gel. The tube was desorbed and the derivatized acetaldehyde was measured by High Performance Liquid Chromatography with UV detection at 360 nm.

Because the NIOSH method resulted in approximately 50-130 bottle volume exchange of air, a second sampling was possible. To do this, the bottles were then sealed shut. This was accomplished by taping the sampling air-inlet hole cut into the bottom of the bottle, with black electrical tape and capping the bottle top with a serum plug then bottle cap. The sealed bottles were placed within a plastic bag and stored on the lab countertop. They were kept in this condition until sampled in the second sampling.

Due to the exhaustive air exchange used during the first testing, it was believed that all acetaldehyde released within the bottle up to that time was removed. Any acetaldehyde found in the second testing represented newly released acetaldehyde. The measurements were taken on Day 81 for Examples 1 and 2 and Day 91 for Examples 3 and 4.

(This methodology cannot differentiate between “free” acetaldehyde originating from further release of entrapped acetaldehyde from initial bottle molding nor from “regenerated” acetaldehyde coming from any other mechanism (i.e. polymer degradation etc). This methodology does not measure any acetaldehyde released from the outer walls of the bottle to the environment.)

Table 3 shows the results, an average of two samples for each Example 1-4 and the Comparative Example A.

TABLE 3
Acetaldehyde Concentration (μg/l) in Head Space of Bottles

| | A | 1 | 2 | 3 | 4 |
|---|---|---|---|---|---|
| Day 11 | 3.42 | 1.55 | 0.99 | | |
| Day 21 | | | | 1.34 | 1.06 |
| Percent | — | 55% | 71% | 61% | 69% |
| Improvement | | | | | |
| over Control | | | | | |
| Day 81 | 2.47 | 0.61 | 0.44 | | |
| Day 91 | | | | 0.73 | 0.60 |
| Percent | — | 75% | 82% | 70% | 76% |
| Improvement | | | | | |
| over Control | | | | | |

Table 3 shows that unexpected and dramatic improvement in minimizing acetaldehyde content in the head space of PET containers is possible by using pure DL-alpha-Tocopherol or modified with an organophosphorus compound. It is believed from the repetitive testing that such acetaldehyde scavenging will continue until the concentration of DL-alpha-Tocopherol is exhausted.

The invention is not limited to the above embodiments. The claims follow.

What is claimed is:

1. A compound, comprising:
(a) polyethylene terephthalate, and
(b) an acetaldehyde scavenger consisting essentially of DL-alpha-Tocopherol present in an amount ranging from about 5% to about 18% of the compound.

2. The compound of claim 1, further comprising colorant.

3. The compound of claim 1, wherein the DL-alpha-Tocopherol is present in an amount ranging from about 5% to about 16.7% of the compound.

4. The compound of claim 1, further comprising an additive selected from the group consisting of slip agents, antiblocking agents, antioxidants, ultraviolet light stabilizers, quenchers, plasticizers, mold release agents, lubricants, antistatic agents, fire retardants, fillers, and combinations thereof.

5. The compound of claim 4, wherein the filler comprises glass fibers, talc, chalk, clay, or combinations thereof.

6. The compound of claim 4, wherein the additive is included in the compound in an amount from 0 to about 40 weight percent.

7. The compound of claim 2, wherein the colorant is either
(a) an inorganic pigment selected from the group consisting of titanium dioxide, iron oxide, chromium oxide, lead chromate, carbon black, silica, talc, china clay, metallic oxides, silicates, chromates, and combinations thereof, or
(b) an organic pigment selected from the group consisting of phthalocyanine blue, phthalocyanine green, carbazole violet, anthrapyrimidine yellow, flavanthrone yellow, isoindoline yellow, indanthrone blue, quinacridone violet, perylene reds, diazo red, and combinations thereof.

8. The compound of claim 7, wherein the amount of colorant can range from none at all to about 4.0 weight percent.

9. A container made from the compound of claim 1.

10. The container of claim 9, further comprising colorant.

11. The container of claim 9, wherein the DL-alpha-Tocopherol is present in an amount ranging from about 5% to about 16.7% of the compound.

12. The container of claim 9, further comprising an additive selected from the group consisting of slip agents, antiblocking agents, antioxidants, ultraviolet light stabilizers, quenchers, plasticizers, mold release agents, lubricants, antistatic agents, fire retardants, fillers, and combinations thereof.

13. The container of claim 12, wherein the filler comprises glass fibers, talc, chalk, clay, or combinations thereof.

14. The container of claim 12, wherein the additive is included in the compound in an amount from 0 to about 40 weight percent.

15. The container of claim 10, wherein the colorant is either
(a) an inorganic pigment selected from the group consisting of titanium dioxide, iron oxide, chromium oxide, lead chromate, carbon black, silica, talc, china clay, metallic oxides, silicates, chromates, and combinations thereof or
(b) an organic pigment selected from the group consisting of phthalocyanine blue, phthalocyanine green, carbazole violet, anthrapyrimidine yellow, flavanthrone yellow, isoindoline yellow, indanthrone blue, quinacridone violet perylene reds, diazo red, and combinations thereof.

16. The container of claim 10, wherein the DL-alpha-Tocopherol is present in an amount ranging from about 5% to about 16.7% of the compound.

17. The container of claim 10, further comprising an additive selected from the group consisting of slip agents, antiblocking agents, antioxidants, ultraviolet light stabilizers, quenchers, plasticizers, mold release agents, lubricants, antistatic agents, fire retardants, fillers, and combinations thereof.

18. The container of claim 17, wherein the filler comprises glass fibers, talc, chalk, clay, or combinations thereof.

19. The container of claim 17, wherein the additive is included in the compound in an amount from 0 to about 40 weight percent.
